(19) United States
(12) Patent Application Publication
(10) Pub. No.: US 2009/0288534 A1
(43) Pub. Date: Nov. 26, 2009

(54) INLINE TAPE CUTTER

(76) Inventors: Jody J. McCoy, Minnetonka, MN (US); Glen Cole, Minnetonka, MN (US); Todd Rasmussen, North Branch, MN (US)

Correspondence Address: GENERAL MILLS, INC., P.O. BOX 1113, MINNEAPOLIS, MN, 55440, US

(21) Appl. No.: 12/436,828

(22) Filed: May 7, 2009

Related U.S. Application Data
(60) Provisional application No. 61/055,479, filed on May 23, 2008.

(51) Int. Cl. B26D 7/10; B26D 7/06

(52) U.S. Cl. 83/171; 83/420; 83/13; 83/426; 83/651.1

(57) ABSTRACT

An inline tape cutter system that manufactures taped packages that can be later-opened without the needed for cutting tools to manual cut packing tape. The inline tape cutter system provides a package engagement assembly having a drive assembly, a cutting arm and an engagement arm, wherein physical contact between the engagement arm and a closed package on a conveyor assembly imparts rotational motion to the drive assembly and directs the cutting arm into contact with the closed package. The cutting arm can include a cutting wire form from a resistive heating element that is capable of burning/cutting packaging tape on the closed package. The inline tape cutter system can include a horizontal positioning assembly and a vertical positioning assembly such that the package engagement assembly can engage a wide variety of package sizes and configuration.

### PRIORITY CLAIM

The present application claims the benefit of U.S. Provisional Application No. 61/055,479, filed May 23, 2008, and entitled, “INLINE TAPE CUTTER”, which is incorporated herein in its entirety by reference.

### TECHNICAL FIELD

The present invention relates generally to the field of automated packaging equipment. More specifically, the present invention is directed to an inline tape cutter for pre-cutting packing tape that has been applied to a package or box to provide an easy-open package.

### BACKGROUND

In warehouse style stores, sometimes referred to as “Club Stores,” products are often displayed it its original shipping packaging or format. In this manner, warehouse stores can utilize basic racks or floor displays as opposed to investing in expensive display shelves.

One drawback associated with utilizing packaging as a display device is that store personnel must typically remove taping and in some instance, portions of the packaging using a cutting device such as, for example, a razor blade, utility knife, scissors or the like. Unfortunately, the use of cutting devices can lead to users suffering cutting and piercing injuries, such as when cutting cardboard and other heavy-duty packaging materials. Not only does the use of these cutting devices increase the likelihood for injury, they also require individuals to spend time to cut open each package. The costs associated with treatment of injuries coupled with the time necessary to manually open each package can be cost prohibitive, especially in warehouse stores where operating margins may be tight to begin with. As such, it would be advantageous to avoid manual cutting of such packages.

### SUMMARY

The inline tape cutter system of the present disclosure addresses the aforementioned needs by providing an apparatus that enables users to access products inside a box or open the box, without using a cutting tool to cut the packing tape or closure. Generally, the inline tape cutter system provides a package engagement assembly comprising a drive assembly, a cutting arm and an engagement arm, wherein physical contact between the engagement arm and a closed package on a conveyor assembly imparts rotational motion to the drive assembly and directs the cutting arm into contact with the closed package. The cutting arm can include a cutting wire form from a resistive heating element that is capable of burning/cutting packaging tape on the closed package. The inline tape cutter system can comprise a horizontal positioning assembly and a vertical positioning assembly such that the package engagement assembly can engage a variety of package sizes and configuration. In some embodiments, the inline tape cutter system can be utilized in conjunction with additional processing/manufacturing equipment so as to allow packages of raw materials to be continually opened for use during the manufacturing process.

In one aspect of the present disclosure, an inline tape cutter system can comprise a package engagement assembly including a drive assembly, a cutting arm and an engagement arm. The engagement arm originally contacts a closed package on a conveyor assembly causing the drive assembly to rotate and direct the cutting arm into a downward direction and into contact with the closed package. The cutting arm generally includes a cutting wire capable of burning/cutting packaging tape holding the package closed. In some embodiments, the cutting wire comprises a resistive heating wire. The inline tape cutter system further includes a horizontal positioning assembly and a vertical positioning assembly such that the package engagement assembly can be adjusted to engage packages having a wide variety of sizes and configuration.

In another aspect of the present disclosure, a method for opening packages closed with packing tape can comprise providing an inline tape cutter assembly in conjunction with a conveyor assembly. The method can further comprise interfacing with a closed package with an engagement arm on the inline taper cutter so as to rotatably direct a cutting arm into contact with the closed package. The method can further comprise cutting the packing tape with a cutting wire on the cutting arm. In some embodiments, the method can further comprise powering the cutting wire such that the cutting wire is heated to burn the packing tape. The method can further comprise adjusting the inline taper cutter in one or both of a vertical or horizontal direction to interface with a variety of different sized closed packages.

The above summary of the various aspects of the disclosure is not intended to describe each illustrated embodiment or every implementation of the invention. The figures in the detailed description that follow more particularly exemplify these embodiments.

### BRIEF DESCRIPTION OF DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a perspective view of an embodiment of an inline tape cutter of the present disclosure.

FIG. 2 is a plan view of the inline tape cutter of FIG. 1.

FIG. 3 is a partial, side view of the inline tape cutter of FIG. 1.

FIG. 4 is a partial, perspective view of the inline tape cutter of FIG. 1.

FIG. 5 is a partially hidden, plan view of the inline tape cutter of FIG. 1.

FIG. 6 is a front view of an embodiment of a tape cutter utilized with the inline tape cutter of FIG. 1.

FIG. 6a is a front view of an embodiment of a tape cutter according to the present invention.

FIG. 7 is a plan view of an embodiment of a display package for opening with the inline tape cutter of FIG. 1.

FIG. 8 is a front, perspective view of an embodiment of a package engagement assembly according to the present invention.

FIG. 9 is a rear, perspective view of the package engagement assembly of FIG. 8.

FIG. 10 is a front view of the package engagement assembly of FIG. 8.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

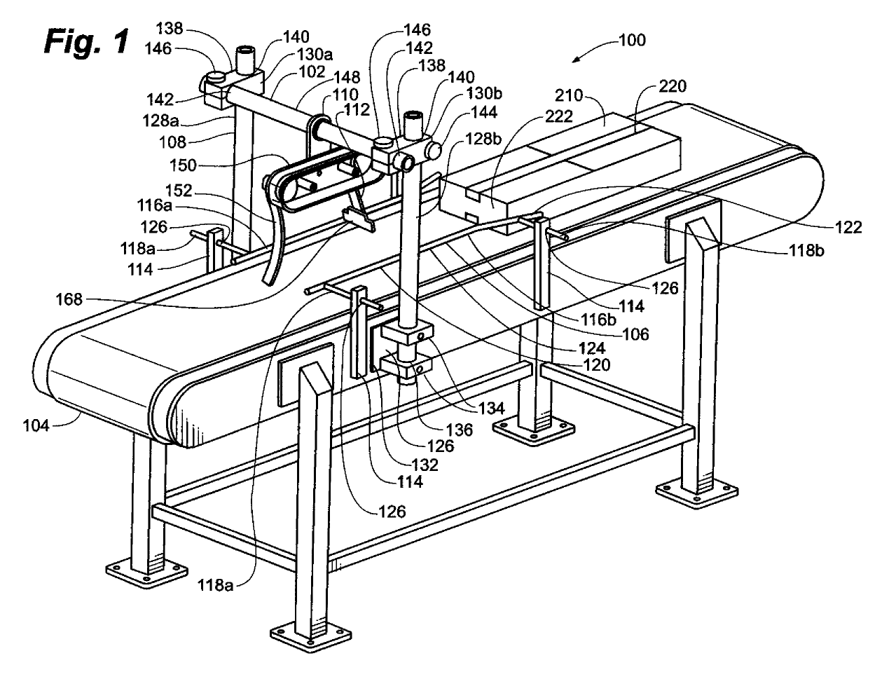

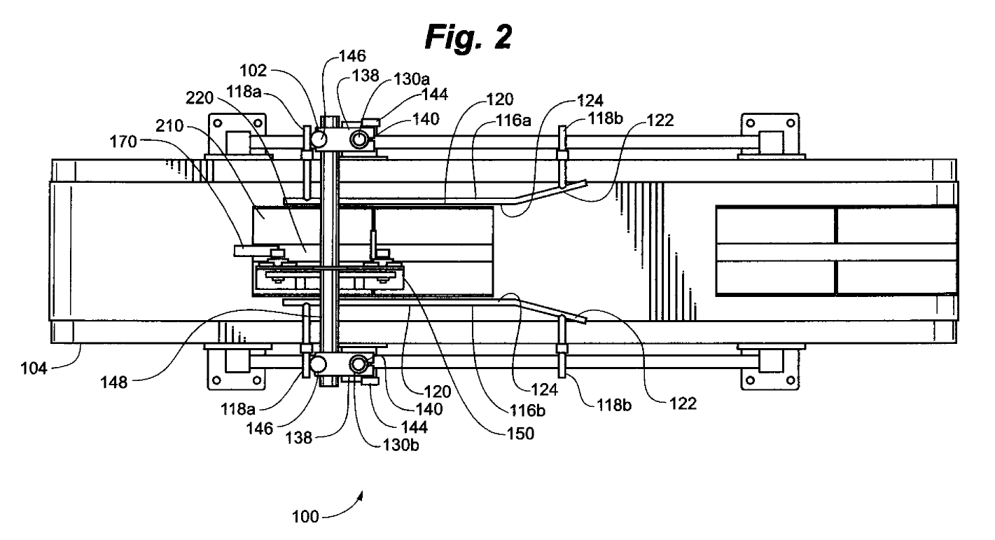

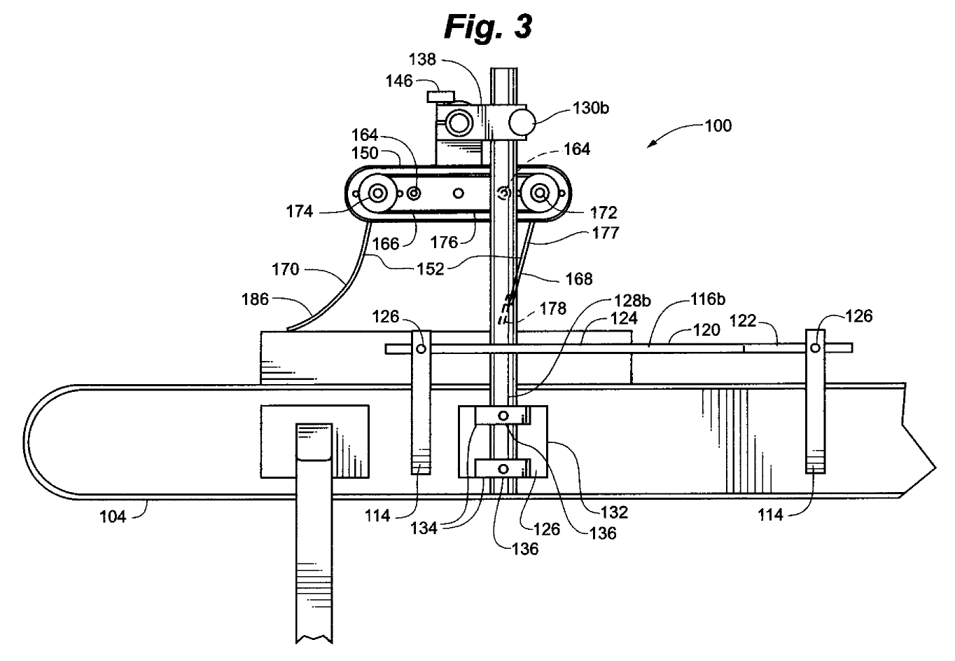

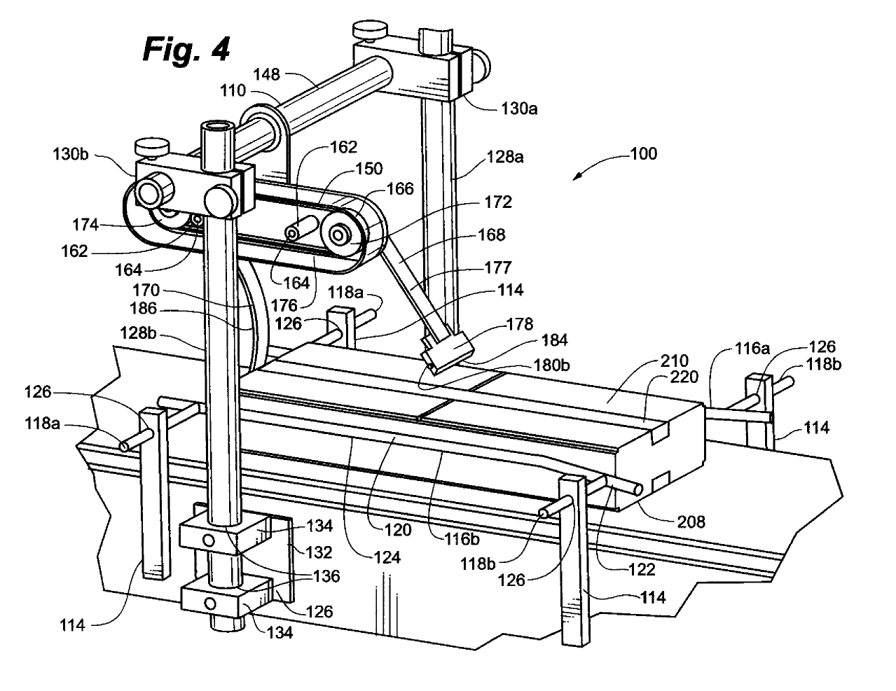

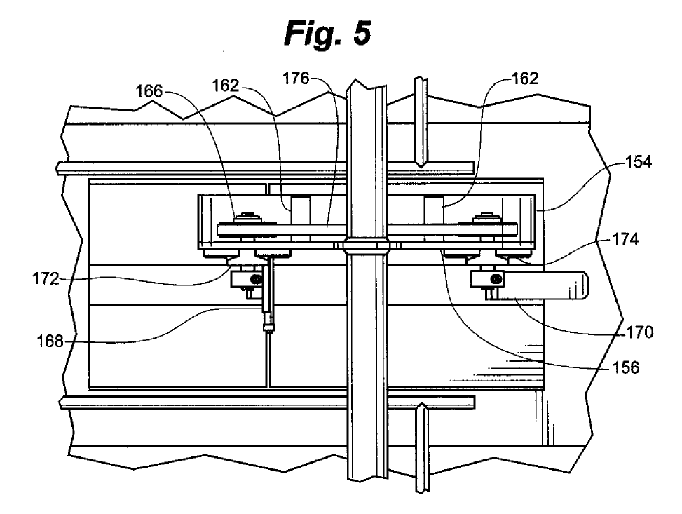

As illustrated in FIGS. 1-5, an inline tape cutter system 100 according to one embodiment of the present disclosure can comprise a cutting system 102 and a conveyor assembly 104. Though conveyor assembly 104 is illustrated simply with no additional manipulation or packaging equipment, it will be understood that conveyor assembly could comprise additional packaging components and that in some embodiments, conveyor assembly 104 can be integral to an automated taping line in which, cutting assembly 102 is located after a taping assembly.

With reference to FIGS. 1-5, cutting system 102 generally comprises a package positioning assembly 106, a vertical positioning assembly 108, a horizontal positioning assembly 110 and a tape cutting assembly 112. Generally, the main structural components of cutting system 102 can comprise materials suitable for integration with conveyor assembly 104 and can include materials such as, for example, aluminum, painted carbon steel, stainless, steel, rigid polymers and the like.

Referring again to FIGS. 1-5, package positioning assembly 106 generally comprises a plurality of mounting members 114 and a pair of guide assemblies 116a, 116b. Each guide assembly 116a, 116b can comprise a pair of adjustment arms 118a, 118b and a package interface arm 120 connected there between. Package interface arm 120 includes a tapered guide portion 122 and an interface portion 124. Each mounting member 114 includes a guide aperture 126 for slidably receiving adjustment arms 118a, 118b.

As shown in FIGS. 1-5, vertical positioning assembly 108 can comprise a pair of mounting brackets 126, a pair of vertical positioning arms 128a, 128b and a pair of vertical adjustment members 130a, 130b. Mounting brackets 126 can each comprise a mounting flange 132 and a pair of receiving members 134. Each receiving member 134 includes a receiving aperture 136 dimensioned so as to accommodate the slidable insertion of vertical positioning arms 128a, 128b. Vertical adjustment members 130a, 130b each comprise an adjustment body 138 having a vertical adjustment aperture 140 and a horizontal receiving aperture 142. Vertical adjustment members 130a, 130b further comprise a vertical tightening member 144 and a horizontal tightening member 146. Vertical adjustment aperture 140 is dimensioned for slidable placement over the vertical positioning arms 128a, 128b whereby vertical tightening member 144 can be used to selectively position and retain the vertical adjustment members 130a, 130b at a desired height.

Horizontal positioning assembly 110 generally comprises a horizontal arm 148 mounted between the vertical adjustment members 130a, 130b. Horizontal arm 148 is sized for slidable insertion into the horizontal receiving apertures 142. Once horizontal arm 148 is positioned within horizontal receiving apertures 142, the horizontal tightening members 146 can be tightened such that the horizontal arm 148 is captured between the vertical adjustment members 130a, 130b. In this fashion, vertical adjustment of the vertical adjustment members 130a, 130b along vertical positioning arms 128a, 128b results in the simultaneous vertical adjustment of horizontal arm 148.

Referring to FIGS. 1-5, tape cutting assembly 112 generally comprises a housing 150 and a package engagement assembly 152. Housing 150 generally comprises a retaining portion 154 and a cover portion 156. Retaining portion 154 comprises at least two mounting projections 162 and two mounting apertures 164 for attaching the cover portion 156. Package engagement assembly 152 generally comprises a drive assembly 166, a tape cutter 168 and a package engagement member 170. Drive assembly 166 can comprise a leading bearing assembly 172, a trailing bearing assembly 174 and a belt 176. Leading bearing assembly 172 and trailing bearing assembly 174 are operably mounted to retaining portion 154 with mounting apertures 164.

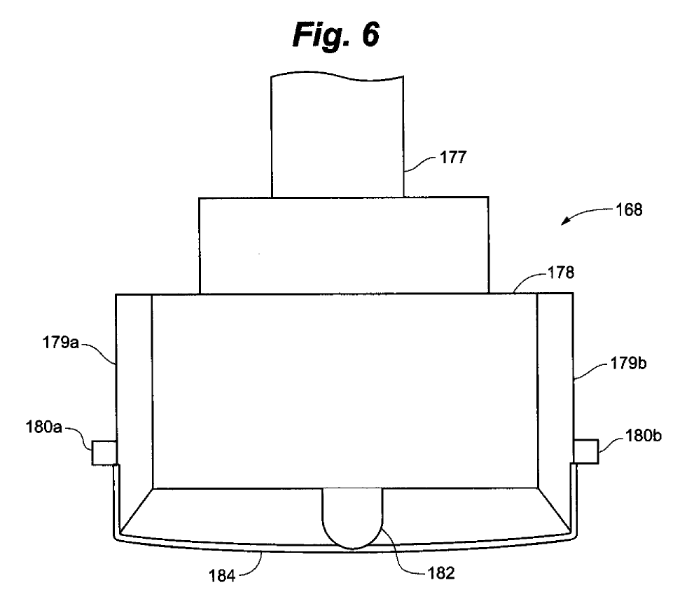

As shown in FIG. 6, tape cutter 168 generally comprises a cutting arm 177, a cutter body 178, a pair of insulating members 179a, 179b, a pair of tensioning members 180a, 180b, a central projecting member 182 and a cutting wire 184. Cutter body 178 includes a pair of tension apertures for receiving a tensioning fastener 186 so as to attach the tensioning members 180a, 180b to the cutter body 178 while simultaneously attaching the cutting wire 184. Central projecting member 182 projects outwardly from the cutter 178 and physically engages the cutting wire 184 so as to cause the projecting wire 182 to assume a generally arcuate disposition 188. Cutting wire 184 generally comprises a suitable resistive element such as, for example, nichrome wire. Cutting arm 176 is generally attached to leading bearing assembly 172. In an alternative embodiment illustrated in FIG. 6a, a taper cutter 190 can similarly comprise cutting arm 177 and cutter body 178 but with the inclusion of a serrated blade 192.

Package engagement member 170 generally comprises an engagement arm 186 operably attached to trailing bearing assembly 174.

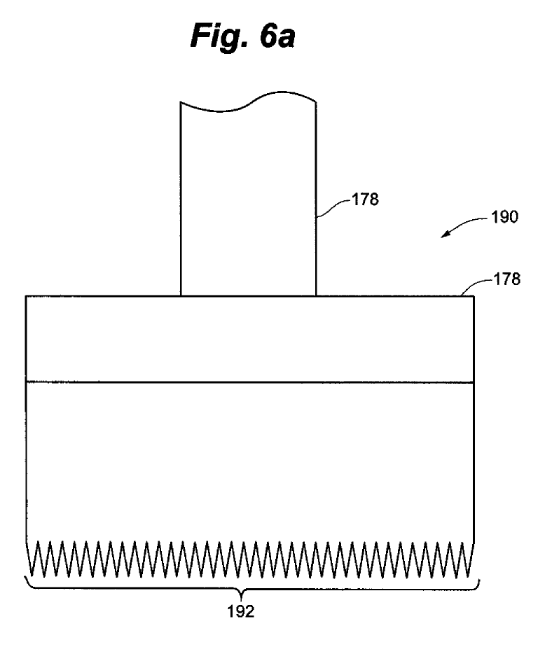

In use, inline tape cutter system 100 is most beneficial in a setting in which a plurality of packages that are dimensionally similar are processed consecutively. In this setting, each package is preferably loaded, closed and taped using an automated system. A representative display package 200 for use with inline tape cutter system 100 is illustrated in generally in FIG. 7. Display package 200 generally comprises a first end 202, a second end 204, sides 206a, 206b, bottom surface 208 and top surface 210. Bottom surface 208 and top surface 210 are generally defined by a pair of exterior flaps 212a, 212b and can include interior flaps 214a, 214b based upon the desired strength and holding capacity of each individual display package 200. Within top surface 210 and second end 204, a display portion 216 can be predefined by a perforated or scored perimeter 218 such that the display portion 216 can be knocked-out so as to display the interior contents to potential purchasers. Generally, display package 200 is retained in a closed disposition following packaging by holding exterior flaps 212a, 212b with a length of packaging tape 220. Typically, packaging tape 220 is of sufficient length to cover the interface of exterior flaps 212a, 212b and extend to first end 202 and second end 204.

Referring now to FIGS. 1-5, an operator initially adjusts the package positioning assembly 106 relative to the width of display package 200. Generally, the operator adjusts the guide assemblies 116a, 116b such that a distance between the package interface arms 120 slightly exceeds the width of first end 202 and second end 204. With the guide assemblies 116a, 116b properly positioned, packaging tape 220 should be arranged generally parallel and centered with respect to the guide assemblies 116a, 116b.

Once positioning assembly 106 has been set, the operator can adjust vertical positioning member 108 to correspond with the height of display package 200. By loosening the vertical tightening members 144, vertical adjustment members 130a, 130b can be slidably positioned along vertical positioning arms 128a, 128b. In this fashion, the tape cutting assembly 112 and more specifically, the vertical position of tape cutter 168 and package engagement member 170 are adjusted to properly interface with display package 200.

With the inline tape cutter system 100 adjusted to horizontally and vertically interface with display package 200, operators can begin placing unopened display packages 200 on the conveyor assembly 104. Generally, each display package 200 is placed on conveyor assembly 104 such that the length of packaging tape 220 is parallel with the path of travel of the conveyor assembly 104. As the unopened display package 200 advances along the conveyor assembly 104 toward the inline tap cutter system 100, a leading edge 222, corresponding to either first end 202 or second end 204, comes into physical contact with the engagement arm 186 of package engagement member 170. As the unopened display package 200 continues its advancement along the conveyor assembly 104, continued contact between the engagement arm 186 and leading edge 222 results in rotational motion being imparted upon the trailing bearing assembly 174, and correspondingly the belt 176. As belt 176 rotates about the trailing bearing assembly 174 and the leading bearing assembly 172, cutting arm 177 is directed in a downward direction such that cutter body 178 approaches top surface 210. As the unopened display package 200 continues along conveyor assembly 104, cutter body 178, and more specifically, cutting wire 184 ultimately comes into contact with the top surface 210a the interface between exterior flaps 212a, 212b.

During operation of the conveyor assembly 104, cutting wire 184 can be continually or intermittently powered such that the cutting wire 184 is heated to a desired operating temperature. In the case of intermittent heating, a switch such as, for example, a proximity switch, photoeye or other motion and/or position based sensor/switch can be used to initiate heating of the cutting wire 184 based upon the position of the unopened display package 200, or any of the components of the package engagement assembly 152. Regardless of the operational mode of cutting wire 184, contact of the cutting wire 184 with the top surface 210 results in burning/cutting of the length of packaging tape 200.

As the display package 200 proceeds to an end of the conveyor assembly 104, the now opened display package 200 can be unloaded from the conveyor assembly 104 for unpacking of any product within the display package 200, or alternatively, the display package 200 can be arranged for stackable presentation in a warehouse purchasing environment.

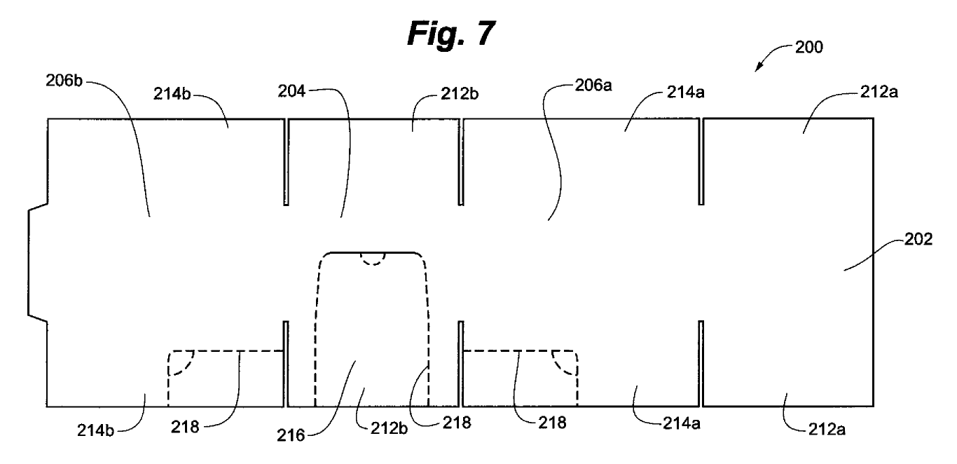

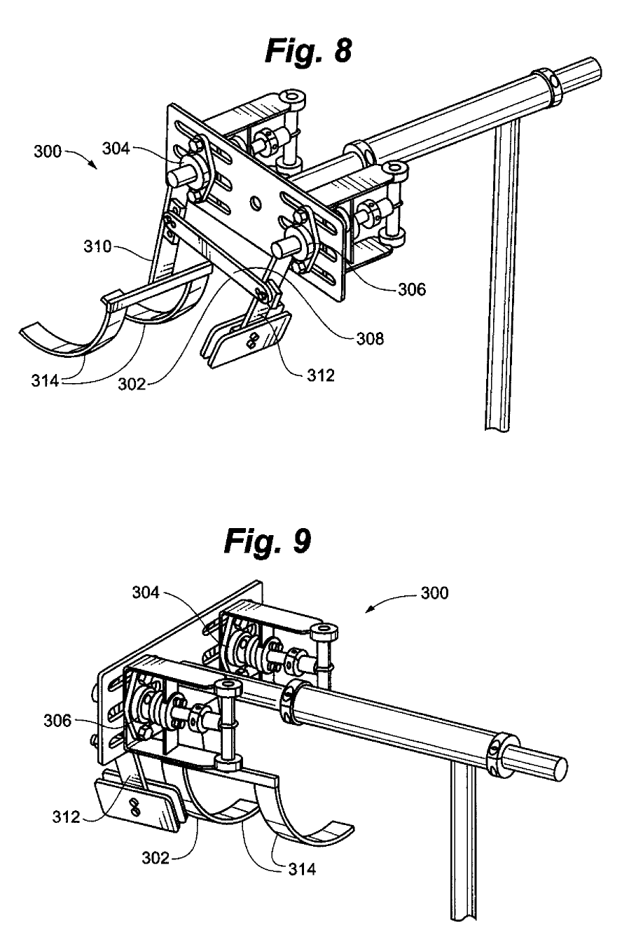

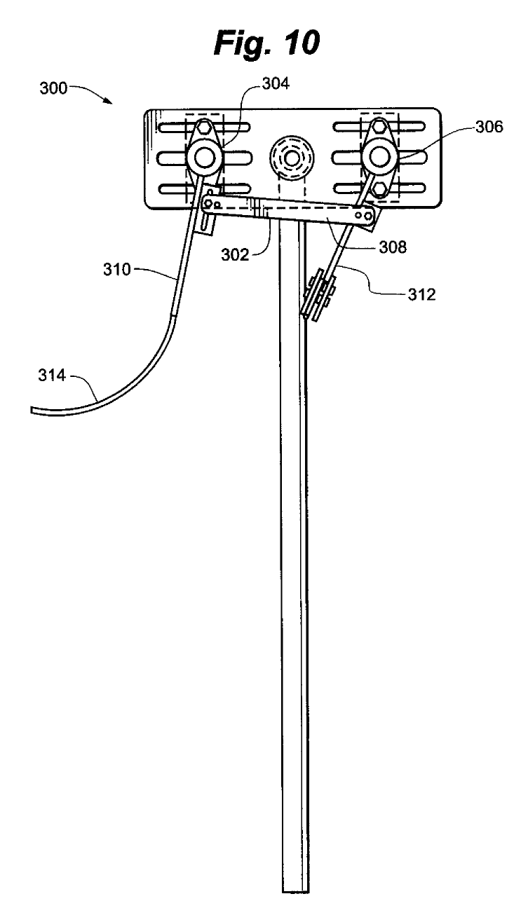

Referring now to FIGS. 8-10, an alternative embodiment of a package engagement assembly 300 can be utilized with inline tape cutter system 100. Package engagement assembly 300 generally comprises a linkage-based drive assembly 302 including a leading bearing assembly 304, a trailing bearing assembly 306 and a linkage member 308. Linkage member 308 is generally operably mounted between an engagement arm 310 and a cutting arm 312. Engagement arm 310 can comprise one or more engagement members 314 configured to engage display package 200 as it carried along conveyor assembly. As the engagement members 314 contact the display package 200, rotational motion is imparted to the engagement arm 310 and to the cutting arm 312 by linkage member 308. Thus, cutting arm 312 is rotatably positioned such that tape cutter 168 can cut or otherwise serrate packaging tape 220.

Through the use of inline tape cutter assembly 100, it can be seen that the use of cutting implements such as, for example, knives, razor blades, scissors and the like can be avoided during unpackaging and display of packaged products. In addition, the vertical and horizontal adjustability of the inline tape cutter assembly 100 allows for application of the inline tape cutter assembly 100 with a wide variety of packaging sizes, shapes and configuration without requiring expensive and time consuming changes to software and other electronic controls. In addition, inline tape cutter assembly 100 can be similarly implemented in a batch or continuous manufacturing environment where packaging containing raw materials used during manufacturing can be continually opened for subsequent use.

While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

What is claimed is:

1. An inline tape cutter comprising:
a packaging positioning assembly having a pair of guide assemblies, wherein each guide assembly includes a tapered guide portion and an interface portion; and
a package engagement assembly including a drive assembly attached to a cutting arm and an engagement arm,
wherein the packaging positioning assembly is adapted to present a closed package for contact with the engagement arm such that the cutting arm rotates into contact with the closed package for cutting a length of packing tape.

2. The inline tape cutter of claim 1, wherein the cutting arm includes a cutting wire arranged in an arcuate disposition.

3. The inline tape cutter of claim 2, wherein the cutting wire comprises a resistive heating element.

4. The inline tape cutter of claim 1, further comprising:
a vertical positioning assembly having a pair of vertical positioning arms, wherein said package engagement assembly is mounted between the vertical positioning arms such that the package engagement assembly can be vertically adjusted to correspond with varying heights of closed packages.

5. The inline tape cutter of claim 4, further comprising;
a horizontal positioning assembly having a horizontal arm mounted between the pair of vertical positioning arms, wherein the package engagement assembly is attached to the horizontal arm.

6. The inline tape cutter of claim 1, wherein the drive assembly includes a leading bearing assembly, a trailing bear assembly and a drive belt and wherein the engagement arm is rotatably attached to the trailing bearing assembly and the engagement arm is rotatably attached to the leading bearing assembly.

7. The inline tape cutter of claim 1, further comprising:
a conveyor assembly onto which the packaging positioning assembly is attached, the conveyor assembly adapted to carry the closed package for positioning by the packaging positioning assembly.

8. A method for opening closed packages comprising;
providing an inline tape cutter assembly operably attached to a conveyor assembly;
advancing a closed package along the conveyor assembly such that an engagement arm on the inline tape cutter assembly engages the closed package; and
rotating a cutting arm operably connected to the engagement arm such that a cutting wire on the cutting arm contacts the closed package and cuts a length of packing tape.

9. The method of claim 8, further comprising:
orienting the cutting wire into an arcuate disposition.

10. The method of claim 9 further comprising:
powering a resistive heating element forming the cutting wire such that the cutting wire is heated to burn the packing tape.

11. The method of claim 8, further comprising;
adjusting a pair of guide assemblies on the inline tape cutter assembly such that the guide assemblies orient the closed package relative to the engagement arm.

12. The method of claim 11, further comprising;
adjusting a pair of vertical positioning arms on the inline tape cutter assembly so as to selectively accommodate a height of the closed package for engagement with the engagement arm and contact with the cutting arm.

13. An inline tape cutting system, comprising:
a conveyor assembly for advancing a closed package, the conveyor assembly including a pair of guide assemblies for positioning the closed package in a desired orientation on a conveyor belt;
a pair of vertical positioning arms attached to the conveyor assembly;
a horizontal positioning arm mounted between the vertical positioning arms such that the horizontal positioning arm is positioned above the conveyor belt; and
a package engagement assembly mounted to the horizontal positioning arm, the package engagement assembly including a drive assembly attached to a cutting arm and an engagement arm, wherein the engagement arm contacts the closed package such that the drive assembly rotatably directs the cutting arm into contact with the closed package for cutting a length of packing tape on the closed package.

14. The inline tape cutting system of claim 13, wherein the cutting arm includes a cutting member, the cutting member selected from the group consisting of a cutting wire, a resistive heating element and a blade.

15. The inline tape cutting system of claim 13, wherein the drive assembly comprises a leading bearing assembly, a trailing bearing assembly and a belt positioned around the leading bearing assembly and the trailing bearing assembly, wherein the engagement arm is coupled to the trailing bearing assembly and the cutting arm is coupled to the leading bearing assembly.

16. The inline tape cutting system of claim 13, wherein the drive assembly comprises a leading bearing assembly, a trailing bearing assembly and a linkage member connecting the leading bearing assembly and the trailing bearing assembly, wherein the engagement arm is coupled to the trailing bearing assembly and the cutting arm is coupled to the leading bearing assembly.

17. The inline tape cutting system of claim 13, wherein the horizontal positioning arm is vertically positionable between the vertical positioning arms to accommodate a variety of package dimensions for the closed package.

18. The inline tape cutting system of claim 13, wherein each guide assembly includes an interface arm having a tapered guide portion for positioning the closed package.
